(19) United States
(12) Patent Application Publication
(10) Pub. No.: US 2010/0318980 A1
(43) Pub. Date: Dec. 16, 2010

(54) STATIC PROGRAM REDUCTION FOR COMPLEXITY ANALYSIS

(75) Inventors: Sumit Gulwani, Redmond, WA (US); Sagar Jain, Raebareli (IN); Eric J. Koskinen, Cambridge (GB)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,180

(22) Filed: Jun. 13, 2009

(51) Int. Cl. G06F 9/45

(52) U.S. Cl. 717/160

(57) ABSTRACT

Described is an analysis tool/techniques for determining the computational complexity of a computer program, including when the program includes procedures having nested loops and/or multi-path loops. First, multi-path loops are converted into code-fragments consisting of simpler loops via a transformation called control flow refinement. Progress invariants are determined for appropriate locations in the procedure to represent relationships between a state that can arise at that program location and the previous state at that location. A bound finding mechanism (such as one based on pattern matching) is then used to compute loop bounds from progress invariants. These bounds are then composed appropriately to determine a precise bound for the enclosing procedure.

### BACKGROUND

Computer programs are often analyzed for their performance characteristics. For example, complexity bounds help programmers understand the performance characteristics of their software implementations.

Known techniques for statically determining bounds of procedures are only able to deal with simple control-flow procedures. Statically determining bounds for procedures with nested loops or multiple paths through a single loop (multi-path loop) is not able to be done with known techniques.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which various techniques are used to reduce the complexity of analyzing a computer program, including when the program has procedures with nested loops and/or multi-path loops. In one aspect, the procedures having multi-path loops is transformed into a procedure with simpler loops.

In one aspect, progress invariants are determined for a location in the procedure, in which the progress invariants represent relationships between a state that can arise at that program location and the previous state at that program location. A bound finding mechanism (such as one based on pattern matching) is then used to compute loop bounds from progress invariants. These bounds are then composed appropriately to determine a precise bound for the enclosing procedure.

In one aspect, control flow refinement, progress invariants and bound finding may be combined into a program analysis tool. The tool may be augmented with existing tools, such as another invariant generation tool.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a program analysis environment for static reduction of procedures of a program.

FIG. 2 is a representation of a procedure used as an example herein.

FIG. 3 is a flow diagram showing example steps in analyzing a software program.

FIG. 4 shows an illustrative example of a computing environment into which various aspects of the present invention may be incorporated.

### DETAILED DESCRIPTION

Various aspects of the technology described herein are generally directed towards a static analysis tool that may be used to statically estimate the worst-case symbolic computational complexity of procedures in terms of the inputs to the procedure. In general, this is accomplished by converting a given procedure with sophisticated loops (i.e., nested loops or single loops with multiple paths) into a procedure with simple loops, using theorem proving technology and techniques similar to that of model checking. The conversion is performed by expanding or abstracting different parts of the original control flow graph of the procedure, using a data-structure referred to as a relational flowgraph that represents relations (as opposed to functions) between the values of variables in two successive iterations of a loop. After converting the procedures, pattern matching is used to compute the symbolic computational complexity of the simple loops.

It should be understood that any examples herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and program analysis in general.

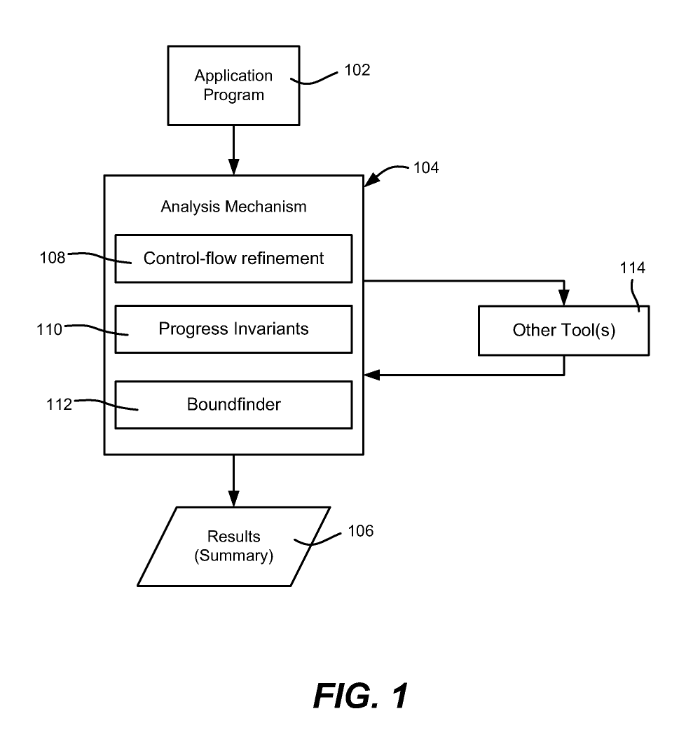

FIG. 1 shows an application program 102 being analyzed by an analysis mechanism 104 to provide results 106 corresponding to a complexity data with respect to that program 102. As described herein, the analysis mechanism 104 includes analysis components that are based upon a control flow refinement technique 108, upon a progress invariants technique 110 and/or a boundfinder technique 112. Also note that the analysis mechanism 104 may leverage one or more other tools 114 in making its analysis, such as an invariant generation tool.

One of the complexities in analyzing programs arises from multi-path loops. Consider the example of an original procedure below, which is adapted from product code:

```
cyclic(int id, maxId):
  assume(0 ≦ id < maxId);
  int tmp := id+1;
  while(tmp != id && nondet( ))
    if (tmp ≦ maxId)
        tmp := tmp + 1;
    else
        tmp := 0;
```

This procedure is a form of “cyclic” iteration; initially tmp is equal to id+1, tmp is incremented until it reaches maxId+1 (along the tmp≦maxId branch), tmp is then reset to 0 (along the else branch), and finally tmp is incremented until it reaches id. It is desired to automatically conclude that the total number of iterations for this loop is bounded above by maxId+1. However, none of the known bound analysis techniques can automatically compute a bound for such a loop because of the mildly complex control flow in the loop. This is because path-sensitive disjunctive invariants are needed to establish a bound.

The control-flow may be represented using a regular expression, letting ρ₁ and ρ₂ denote the increment and reset branches, respectively. Then, the path interleavings in the example loop can be more precisely described by the refinement (ρ*₁ ρ₂ ρ*₁)|(ρ*₁) of the original control-flow (ρ₁|ρ₂)*. While (ρ₁|ρ2)* suggests that paths ρ₁ and ρ₂ can interleave in an arbitrary manner, the refinement (ρ*₁ρ₂ρ*₁)|(ρ*₁) explicitly indicates that path ρ₂ executes at most once.

Described herein is how such a refinement can be carried out automatically, and how it enables bound computation, via a technique called control-flow refinement. In general, rather than abstracting the control-flow, which blurs interleavings, the technique instead refines the control-flow by making the interleavings more explicit. Subsequently, an invariant generation tool may determine that some paths are infeasible, for example, often resulting in a procedure that is easier to analyze.

The following shows the original program re-written using a notation (described below) that uses assume statements to replace all conditionals with non-deterministic choices:

```
cyclic(int id, maxId):
  assume(0≦id<maxId);
  int tmp := id+1;
  Repeat(Choose({ρ₁, ρ₂}));
```

The “Repeat” line repeatedly executes its argument a non-deterministic (0 or more) number of times, as long as the corresponding assume statements are satisfied. Repeat⁺ (exemplified below) is identical to Repeat except that it executes its argument at least once. The “Choose” selects non-deterministically among its arguments (i.e., among those that satisfy the corresponding assume statements).

The following table illustrates an aspect of the control-flow refinement, comprising a semantics and bound preserving expansion of a multipath loop, wherein Repeat(Choose({ρ₁, ρ₂})) is replaced by a choice between one of the following:
Loop does not execute: “skip”
Only ρ₁ executes, at least once: “Repeat+(ρ₁)”
Only ρ₂ executes, at least once: “Repeat+(ρ₂)”
ρ₁ executes first, at least once, followed by the execution of ρ₂, and finally a non-deterministic interleaving of ρ₁ and ρ₂: “Repeat+(ρ₁); ρ₂; Repeat(Choose({ρ₁, ρ₂}))”
ρ₂ executes first, at least once, followed by the execution of ρ₁, and finally a non-deterministic interleaving of ρ₁ and ρ₂: “Repeat+(ρ₂); ρ₁; Repeat(Choose({ρ₁, ρ₂}))”

cyclicref (int id, maxId):
1 assume(0≦id<maxId);
2 int tmp := id+1;
3 Choose({
4 skip,
5 Repeat+(ρ₁),
6 Repeat+(ρ₂),
7 Repeat+(ρ₁) ;ρ₂;Repeat(Choose({ρ₁, ρ₂})),
8 Repeat+(ρ₂) ;ρ₁;Repeat(Choose({ρ₁, ρ₂})),
9 });

A general form of this expansion for loops with more than two paths is described below. The following table shows the refined version of the program obtained from the expanded program, after simplification with the help of an invariant generation tool. Here ρ₁, [symbol] assume(tmp≠id [symbol] tmp≦maxId); tmp:=tmp+1; and ρ2 [symbol] assume(tmp≠id [symbol] tmp>maxId); tmp:=0.

cyclic^{pruned}(int id, maxId):
1 assume(0 ≦ id < maxId);
2 int tmp := id+1;
3 Choose({
4 skip,
5 Repeat+(ρ₁);ρ₂;Repeat(ρ₁),
6 Repeat+(ρ₁)
7 });

Note that (in the original unrefined version of the program), the multi-path loop at line 7 has the invariant id≦tmp<maxId; hence only path ρ₁ is feasible inside the multipath loop at lines 7. Also, line 3 has the invariant id≦maxId; hence path ρ₁ is infeasible at the start of lines 8 and 6. These invariants may be computed by any of several standard (conjunctive, path-insensitive) linear relational analyses.

The simplification used to obtain the final refined loop from the expanded loop may not always be possible after one expansion, but may require repeated expansion of multi-path loops. This raises an issue of termination of the expansion step, which is addressed below.

The number of iterations of each loop may be bounded using the progress invariants technique 110 described below. Thus, it can be established that the two loops Repeat⁺ (ρ₁) at line 5 run for at most maxId-id iterations and id iterations, respectively, while the loop Repeat⁺ (ρ₁) at line 6 runs for at most maxId−id iterations. This implies a bound of maxId+1 on the number of iterations of the loop in the original program

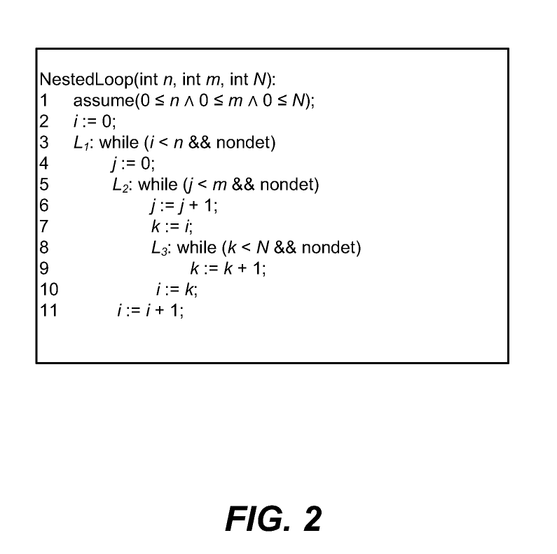

Turning to nested loops, consider the procedure below (also shown in FIG. 2), which is an example of nested loops (triple-nested) with related iterator variables, seen commonly in product code. Such loops often arise when an inner loop is used to “skip ahead” through progress bounded by an outer loop.

NestedLoop(int n, int m, int N):
1 assume(0 ≦ n [symbol] 0 ≦ m [symbol] 0 ≦ N);
2 i := 0;
3 L₁: while (i < n && nondet)
4 j := 0;
5 L2: while (j < m && nondet)
6 j := j + 1;
7 k := i;
8 L₃: while (k < N && nondet)
9 k := k + 1;
10 i := k;
11 i := i + 1;

It can be seen that the values of the loop iterator variables i, j, and k increase in each iteration of the corresponding loop, and hence the complexity of the above loop is O(n×m×N). However, this is an overly conservative bound. Note that the total number of iterations of the innermost loop L₃ is bounded by N (as opposed to n×m×N) since the value of the iterator k at the entry to loop L₃ is greater than or equal to the value of k when loop L₃ was last executed. Hence, the total combined iterations of all the three loops is bounded above by n+(m×n)+N. No known existing bound analysis technique is able to compute a precise bound for the above procedure.

Described is a technique based on progress invariants for computing the precise bound of n+(m×n)+N for the total number of all loop iterations; it can be proved that the total number of iterations of the innermost loop are bounded above by N. Note that the procedure in the example code is already control-flow refined, as none of the loops are multi-path loops.

A type of invariant described herein as “progress invariants” characterize the sequence of states that arise at a given program location in between any two visits to another program location. Progress invariants are used in one bound computation algorithm (described below) to find more a precise bound than other known techniques based on structure decomposition. The progress invariants (parameterized over an abstract domain D) are:
INIT_{D}(P, π₁, π₂) denotes the property of the initial state of procedure P that can arise during the first visit to location π₁ after any visit to location π₂.
NEXT_{D}(P, π₁, π₂) denotes the relationship between a state (over program variables \vec{x}) at a given program location π₁ and the previous state (over fresh variables \vec{x}_{old}) at that location, in between any two visits to location π₂.

The algorithms that compute the progress invariants INIT_{D} and NEXT_{D} given a standard invariant generation tool are described below. For the NestedLoop example of FIG. 2, standard relational linear analyses can generate the following progress invariants, where π₀ is the entry point of procedure NestedLoop and π₃ is the program point just inside loop L₃.

NEXT_{D}(NestedLoop, π₀, π₃): (k_{old}≦k) [symbol] (0≦k<N)

INIT_{D}(NestedLoop, π₀, π₃): k=0

A bound analysis engine (described below) is able to conclude from the above invariants that the number of times location π₃ is visited (after the last visit to location π₀) is bounded above by N.

Turning to another aspect, a formal model of these techniques is described using some notation that describes path refinement and a method of calculating procedure bounds. For simplicity, assume that each procedure P is described as a statement s using the following structural language:

s ::= s₁;s₂ | Repeat(s) | Choose({s₁,..,sₜ})
| x := e | assume(cond) | skip

where x is a variable from the set of all variables \vec{x}, e is some expression, and cond is some Boolean expression. The expression e can contain procedure calls.

The above model has the following intuitive semantics. Since there are non-deterministic conditionals, its semantics can be characterized by showing its operational semantics on a set of states. The following function [[s]]σ illustrates how a statement s transforms a set σ of concrete states.

| | |
|---|---|
| [[skip]]σ | = σ |
| [[s₁;s₂]]σ | = [[s₂]]([[s₁]]σ) |
| [[Choose({s₁,..,sₜ})]]σ | = [[s₁]]σ ∪..∪ [[sₜ]]σ |

| | |
|---|---|
| [[Repeat(s)]]σ | = σ∪[[s;Repeat(s)]]σ |
| [[x := e]]σ | = {δ[x [symbol] δ(e)] \| δ ε σ} |
| [[assume(cond)]]σ | = {δ \| δ ε σ,δ(cond) = true} |

The framework is parameterized by a standard abstract domain D, with an abstract element denoted E. However operations in the abstract domain only occur in the invariant generator INVARIANT_{D}. The only abstract element which appears explicitly in the algorithms is the minimal/bottom element ⊥_{D}. The techniques are interoperable with a variety of existing tools, and thus APIs may be used, as described herein. For example, consider an invariant generator INVARIANT_{D}(P, π, S_{D}(\vec{x}))→S_{D}^{R}(\vec{x}, \vec{x}) takes a procedure P, a program point π, and an abstract state S_{D} over input program variables \vec{x}, and returns an invariant S_{D}^{R} that holds at π. This invariant generator can be for any abstract domain D.

The above-described control-flow refinement technique is a semantics-preserving and bound-preserving unrolling transformation of loops within a procedure. More specifically, a loop having multiple paths (resulting from a conditional) is refined into one or more loops in which the interleaving of paths is syntactically explicit. Subsequently, an invariant generation tool may determine that some paths are infeasible, often resulting in an overall procedure that is easier to analyze.

A REFINE algorithm, set forth below, performs control-flow refinement of a multi-path loop sₗₒₒₚ in the initial state E, and returns a procedure that is semantically equivalent in the input state E.

REFINE( [symbol] : Procedure, sₗₒₒₚ:Repeat statement)
1 let sₗₒₒₚ be Repeat(s) occurring at location π in [symbol] .
2 E := INVARIANT_{D}(P,π,true);
3 s := Flatten(s);
4 Q := Push(E,Empty_Stack);
5 (sᵣₑₛᵤₗₜ,Z) := [symbol] (s,Q);
6 return P with sₗₒₒₚ replaced by sᵣₑₛᵤₗₜ; [symbol]
(s:Flattened stmt, Q:stack of abstract elements)
1 let s be of the form Choose({ρ₁,..,ρₜ}).
2 E := Top(Q);
3 for i = 1 to t
4 sᵢ := (Repeat⁺(ρᵢ);Choose({ρ₁,..,ρᵢ₋₁,ρᵢ₊₁,ρₜ}));
5 πₑₓ := exit point of sᵢ;
6 E′ := INVARIANT_{D}(sᵢ,πₑₓ,E);
7 if (E′ = ⊥_{D}) s′ := ⊥;
8 else if (∃Eₜ ∈ Q s.t.E′ = Eₜ) Zᵢ := {E′};
9 else (s′,Zᵢ) := [symbol] (s,Push(Q,E′)); sᵢ := sᵢ;s′;
10 S_{if} := {skip}; S_{wh} := ;
11 for i = 1 to t
12 S_{if} := S_{if} ∪ {Repeat⁺(ρᵢ)};
13 if (sᵢ = ⊥) continue;
14 if (∃Eₜ ∈ Zᵢ s.t.Eₜ = E) S_{wh} := S_{wh} ∪ {sᵢ};
15 else S_{if} := S_{if} ∪ {sᵢ};
16 Z := Z ∪ Zᵢ − {E};
17 return (Choose(S_{if} ∪ Repeat(Choose(S_{wh}))),Z);

The REFINE algorithm uses an operation called “Flatten” to flatten a statement:

Given a statement s, Flatten(s) is defined to be a statement of the form Choose({ρ₁, . . . , ρₜ}) such that for any set of states σ,

[[s]]σ=[[Choose({ρ₁, . . . , ρₜ})]]σ

where each ρᵢ is a straight-line sequence of atomic x:=e or assume statements or Repeat loops (and, no Choose statements). Such ρᵢ is referred to as a path. The flatten operation can be implemented as:

Flatten(s)=Choose(F(s))

where the function F(s) maps a statement s into a set of straight-line sequences as follows:

| | |
|---|---|
| F(s₁;s₂) | = {ρ₁;ρ₂ \| ρ₁ ∈ F(s₁),ρ₂ ∈ F(s₂)} |
| F(Choose({s₁,..,sₜ})) | = F(s₁)∪..∪F(sₜ) |
| F(s) | = {s} for all other s |

By way of example, consider the following code fragment:

$$s {=}^{def} if c then {s}_{1} else {s}_{11} ; {s}_{2} ; if {c}^{′} then {s}_{3} ;$$

Flattening of the above code fragment yields, in the above-described notation:

```
Choose({ assume(c);s₁;s₂;assume(c′); s₃,
          assume( [symbol] c);s₁₁;s₂;assume(c′);s₃,
          assume(c);s₁;s₂;assume( [symbol] c′),
          assume( [symbol] c);s₁₁;s₂;assume( [symbol] c′) })
```

The REFINE procedure makes uses the following property that describes how a flattened, multi-path loop can be unfolded into 2t+1 different cases depending on which loop path iterates first, and whether any other path iterates afterwards. This is the generalization of the two path loop described above.

Property: Let s and sᵢ (for 1≦i≦t) be as follows.

$$s {=}^{def} Choose ( \{ {ρ}_{1} , … , {ρ}_{t} \} )$$

$${s}_{i} {=}^{def} {Repeat}^{+} ( {ρ}_{i} ) ; Choose ( \{ {ρ}_{1} , … , {ρ}_{i - 1} , {ρ}_{i + 1} , … , {ρ}_{t} \} ) ; Repeat ( s )$$

$${s}_{i}^{′} {=}^{def} {Repeat}^{+} ( {ρ}_{i} ) ;$$

Then, for any set of states σ:

[[Repeat(s)]]σ=[[Choose({skip, s₁, . . . , sₜ, s′₁, . . . , s′ₜ})]]σ

Of these 2t+1 cases, there are t cases (corresponding to s₁, . . . , sₜ) that have multi-path loops, which are then further refined recursively. To ensure termination, an underlying invariant generator INVARIANT_{D} is used to compute the state before each newly created multi-path loop. The process then either stops the recursive exploration (if INVARIANT_{D} can establish unreachability), puts a backedge (if INVARIANT_{D} finds a state already seen), or uses widening heuristics (in case INVARIANT_{D} generates invariants over an infinite domain).

For this purpose, the REFINE algorithm invokes a recursive algorithm R on the flattened body s of the input loop, along with a stack containing the element E, which is the only input configuration seen before any loop. The recursive algorithm R consumes a flattened loop body s and a stack Q of abstract elements. Q represents the input abstract states immediately before the while loop Repeat(s) seen during the earlier (but yet unfinished) recursive calls to R. R returns a pair (s″,Z) where s″ is a statement and Z is a set of input abstract states that were re-visited by the recursive algorithm during the refinement and used to terminate exploration while arranging a nested loop at appropriate places. The first loop in R (Lines 3-9) recursively refines the t cases (s1, . . . , sₜ) from the above property that have multi-path loops, one by one. R refines sᵢ by choosing between one of the following possibilities depending on the element E′ computed before the multi-path loop in sᵢ:
Stop exploration (Line 7) if E′=⊥_{D}, denoting unreachability.
Create a nested loop (Line 8) if E′ belongs to stack Q (i.e. it is an input state that has been seen before). Further exploration is stopped and E′ is returned to denote the place where the nested loop needs to be created.
Pursue more exploration (Line 9) otherwise, recursively.

If the abstract domain D is a finite domain, then the first loop in R terminates because the algorithm is never recursively invoked with the same input state E twice. Otherwise additional measures are needed to ensure termination. One way to ensure termination this is to override the equality check in Line 8 with “return true” if the size of stack Qᵢ becomes equal to some preselected constant. Another way to accomplish this is with a widening algorithm associated with the domain D, wherein the contents of the stack Qᵢ are treated as that of the corresponding widening sequence for purpose of checking equality. The second loop in R (Lines 11-16) puts together the result of refining the t recursive cases along with the other t+1 cases. S_{wh} collects the cases to be put together inside a loop at the current level of exploration (thereby arranging a nested loop), while S_{if} collects the other cases.

The following theorem states that control-flow refinement is semantics-and bound-preserving:
Theorem (Control-Flow Refinement) For any loop sloop inside a procedure P, and any set of initial states σ

[[REFINE(P, sₗₒₒₚ)]]σ=[[P]]σ

Also, REFINE(P, sₗₒₒₚ) and P have the same complexity bound.

The following table exemplifies non-trivial iterator patterns found in product code that share very similar syntactic structure, namely a single multi-path loop with two paths (iterating over variables that range over 0 to n or m). As can be seen, the process of control-flow refinement results in significantly different (but, each easier to analyze) looping structures, because of the different ways in which the two paths interleave (which is made explicit by the control-flow refinement technique). In particular, exemplified are nested loops, sequential loops and a choice of loops, which correspond to significantly different bounds.

| Original | Refined |
|---|---|
| Example 1: | |
| cyclic(int id, n): | cyclic^{pruned}(int id, n): |
| assume(0 ≦ id < n); | assume(0 ≦ id < n); |
| int tmp := id+1; | int tmp := id+1; |
| while(tmp6=id && nondet) | Choose({ |
| if (tmp ≦ n) | skip, |
| tmp := tmp + 1; | Repeat+(ρ₁);ρ₂;Repeat(ρ₁), |
| else | Repeat+(ρ₁) |
| tmp := 0; | }); |
| | Bound: n |
| Example 2: | |
| assume(n>0 [symbol] m>0); | assume(n > 0 [symbol] m > 0); |
| v1 := n; v2:= 0; | v1 := n; v2:= 0; |
| while (v1>0 && nondet) | Choose({ skip, |
| if (v2<m) | Repeat(Repeat+(ρ₁); ρ₂), |
| v2++; v1−−; | Repeat+(ρ₁) |
| else | }); |
| v2:=0; | assume(v1≦ 0); |
| | where ρ₂ [symbol] assume(v1 > 0); v2:=0; |
| | ρ₁ [symbol] assume(v1 > 0 [symbol] v2 <m);v2++;v1−−; |
| | $Bound \text{:} \frac{n}{m} + n$ |
| Example 3: | |
| assume (0<m<n); | assume(0<m<n); |
| i := 0; j := 0; | i := n; |
| while (i<n && nondet) | Choose({ skip, |
| if (j<m) j++; | Repeat(Repeat+(ρ₁); ρ₂), |
| else j := 0; i++; | Repeat+(ρ₁) |
| | }) |
| | where ρ₁ [symbol] assume(i < n [symbol] j < m);j++; |
| | ρ₂ [symbol] assume(i<n [symbol] j≧m);j:=0;i++; |
| | Bound: n × m |
| Example 4: | |
| assume (0<m<n); | assume(0<m<n); |
| i := n; | i := n; |
| while (i>0 && nondet) | Choose({ skip, |
| if (i<m) i−−; | Repeat+(ρ₂); Repeat(ρ₁), |
| else i := i-m; | Repeat+(ρ₂) |
| | }) |
| | where ρ₁ [symbol] assume(l > 0 [symbol] l <m);i−−; |
| | ρ₂ [symbol] assume(i>0 [symbol] i≧m);i:=i-m; |
| | $Bound \text{:} \frac{n}{m} + n$ |
| Example 5: | |
| assume(0 < m < n); | assume(0 < i < n); |
| i := m; | Choose({ skip, |
| while (0 < i < n) | Repeat+(ρ₁), |
| if (dir=fwd) i++; | Repeat+(ρ₂), |
| else i−−; | }) |
| | where ρ₁ [symbol] assume(dir=fwd);i++; |
| | ρ₂ [symbol] assume(dir≠fwd);i−−; |
| | Bound: max(m, n − m) |

Existing techniques for computing complexity bounds are often imprecise. As described above, progress invariants may be used in the computation, that is, the INIT_{D}(P, π₁, π₂) and NEXT_{D}(P, π₁, π₂) relation, which are associated with two program locations π₁ and π₂ inside a procedure P.

Progress invariants are used to reason about the progress of one particular loop with respect to another loop. As a result, a bound computation algorithm (described below), can be precise. Referring again to the triple-nested loop example of FIG. 2, the innermost loop (effectively) increments the same counter as the outermost loop.

A simple transformation on a procedure called SPLIT is useful for computing INIT_{D} and NEXT_{D}. SPLIT(P, π) takes a procedure P and a program location π(inside P) as inputs and returns (P′, π′, π″), where P′ is the new procedure obtained from P by splitting program location π into two locations π′ and π″ such that the predecessors of π are connected to π′ and the successors of π are connected to π″, and there is no connection between π′ and π″. The SPLIT transformation is a building block that is used to compute the two progress invariant relations as described below.

NEXT_{D}(P, π₁, π₂) is defined to be a relation over variables \vec{x} (those that are live at location π₂) and their counterparts \vec{x}_{old} that describes the relationship between any two consecutive states that arise at π₂ without an intervening visit to location π₁. More formally, let σ₁, σ₂, . . . , denote any sequence of program states that arise at location π₂ after any visit to location π₁, but before any other visit (to π₁). Let σ_{i,i+1} denote the state over \vec{x} ∪ \vec{x}_{od} such that for any variable x ∈ \vec{x}, σ_{i,i+1}(x_{old})=σᵢ(x) and σ_{i,i+1}(x)=σ+ᵢ₊₁(x). Then, for all i, σ_{i,i+1} satisfies the relation NEXT_{D}(P, π₁, π₂). NEXT_{D} may be computed as follows using an invariant generator:

NEXT_{D}( [symbol] ,π₁,π₂):
1 E₁ := INVARIANT_{D}( [symbol] ,π₂,true);
2 ( [symbol] ,π₁′,π₁″) := SPLIT( [symbol] ,π₁);
3 ( [symbol] ,π₂′,π₂″) := SPLIT( [symbol] ,π₂);
4 Let [symbol] be [symbol] with entry point changed to π₂″
and instrumented with x_{old} := x at π₂″;
5 E₂ := INVARIANT_{D}( [symbol] ,π₂′,E₁);
6 return E₂;

This algorithm begins by using an invariant generation procedure to generate an abstract element as a loop invariant for π₂ (Line 1). Two transformations are then performed on the flow graph: the region of interest (all paths from π₂ to π₂ that do not pass through π₁) is isolated by eliminating the path from π₁ to π₂ (Lines 2 and 4), and π₂ is instrumented with \vec{x}_{old}:=\vec{x} (Lines 3 and 4). A new invariant at π′₂ (Line 5) is computed, seeded with the original loop invariant.

Returning again to the triple nested loop example, it is useful (as described below) to obtain a NEXT_{D} invariant for each nested loop L with respect to its dominating loops L′. Let π₁ be the program point just inside loop L₁; similar for π₂ and π₃. For this example, an invariant generator may find (among other things):

NEXT_{D} (NL, π₀, π₁):i≧i_{old}+1 [symbol] i<n

NEXT_{D} (NL, π₁, π₂):j=j_{old}+1 [symbol] j<m

NEXT_{D} (NL, π₀, π₃):k≧k_{old}+1 [symbol] k<N

As described herein, these invariants may be used to obtain a bound.

Note that these expressions describe the progress of variables with respect to outer loop iterations. For example, at π₃, k is always greater than or equal to k_{old}+1, and the loop invariant is that k≦N. this may be used to conclude that the total number of loop iterations of L₃ is bounded by N.

INIT_{D}(P, π₁, π₂) is a relation over variables \vec{x} (those that are live at location π₂) that describes the state that can arise during the first visit to π₂ after any visit to location π₁. INIT_{D} may be computed as follows, using an invariant generator INVARIANT_{D}:

INIT_{D}( [symbol] ,π₁,π₂):
1 E₁ := INVARIANT_{D}( [symbol] ,π₁,true);
2 ( [symbol] ,π₁′,π₁″) := SPLIT( [symbol] ,π₁);
3 ( [symbol] ,π₂′,π₂″) := SPLIT( [symbol] ,π₂);
4 Let [symbol] be [symbol] with entry point changed to π₁″.
5 E₂ := INVARIANT_{D}( [symbol] ,π₂′,E₁);
6 return E₂;

This algorithm is similar to the algorithm used to compute NEXT_{D}, but has differences. First, the initial abstract element E₁ holds at π₁ (Line 1). Second, the transformation preserves the path from π₁ to π₂ (Line 4) and false holds on all edges out of π′₂. Note that there is no need to compute invariants over relationships over the value of variables between two successive states (hence there is no instrumentation step). The algorithm therefore computes invariants that hold the first time π₂ is reached coming from π₁, rather than loop invariants over π₂.

Again returning to the triple nested loop example, a standard invariant generation tool may find (among other things):

INIT_{D}(NL, π₀, π₁):i=0

INIT_{D}(NL, π₁, π₂):j=0

INIT_{D}(NL, π₀, π₃):k≧0

Progress invariants have applications beyond complexity bounds, such as to prove fair termination. Progress invariants are strictly stronger than transition invariants; both forms describe relationships between two states at the same program point, however, progress invariants compare two subsequent states at a program point rather than comparing a state with any previous state, as is the case for transition invariants.

A purpose of INIT_{D} is to study properties of the first element represented in the sequence NEXT_{D} (invoked with the same arguments). These invariants may be used to obtain a bound.

Turning to bound computation, progress invariants can be used to compute precise bounds. This technique can be applied to any procedure, but herein is applied to procedures for which control-flow refinement has been performed to make the path interleavings of a multi-path loop more explicit. The notation is that for any loop L in procedure P, T(L) is defined to be the upper bound on the total number of iterations of L in procedure P. For any loops L, L′ such that L is nested inside L′, I(L,L′) is defined to be the upper bound on the total number of iterations of L for each iteration of L′.

Computing complexity bounds is based upon the task of calculating the number of iterations of a loop. This procedure is named BOUNDFINDER; it consumes an abstraction of the initial state of the loop (given in some abstract domain D) as well as an abstraction of the relation between any two successive states in a loop. These abstractions are given by the progress invariants INIT_{D} and NEXT_{D} as described above. The output is

I(L, L′)=BOUNDFINDER_{D} (INIT_{D}( [symbol] , π′, π) NEXT_{D} ( [symbol] π′, π), V)

T(L)=BOUNDFINDER_{D} (INIT_{D}( [symbol] , πₑₙ, π), NEXT_{D} ( [symbol] πₑₙ, π), V)

where π is the first location inside loop L, π′ is the first location inside loop L′, πₑₙ is the entry point of procedure P, and V is the set of all input variables. Again using the example of FIG. 2, from the progress, BOUNDFINDER concludes that the total number of iterations of loops: T(L₃)=N and T(L₁)=n. Moreover, BOUNDFINDER concludes that the number of iterations of loop L₂ per iteration of L₁ is: I(L₂,L₁)=m. These quantities allow computing a final bound of n+(m+n)+N using the equations described below.

BOUNDFINDER can be implemented in a variety of ways. One potential way to implement BOUNDFINDER is with counter instrumentation. Alternatively BOUNDFINDER can be implemented via unification against a database of known loop iteration lemmas.

In order to compute a precise bound, BOUND(s), on a statement s in procedure P, B(s) is defined recursively as follows:

$$\begin{matrix} ( s ) = ( 1 , ∅ ) for s ∈ \{ skip , x := e , assume ( c ) \} & ( 1 ) \\ \begin{matrix} ( Choose ( \{ {s}_{1} , … , {s}_{t} \} ) ) = ( Max \{ {c}_{1} , … , {c}_{t} \} , {Z}_{1} ⋃ … ⋃ {Z}_{t} ) \\ where ( {c}_{i} , {Z}_{i} ) \\ = ( {s}_{i} )\end{matrix} & ( 2 ) \\ \begin{matrix} ( {s}_{1} ; {s}_{2} ) = ( {c}_{1} + {c}_{2} , {Z}_{1} ⋃ {Z}_{2} ) \\ where ( {c}_{1} , {Z}_{1} ) \\ = ( {s}_{1} ) and ( {c}_{2} , {Z}_{2} ) \\ = ( {s}_{2} )\end{matrix} & ( 3 ) \\ ( L \text{:} Repeat ( {s}^{′} ) ) = ( 0 , Z ⋃ ( c , L ) ) \\ where c = {c}^{′} + {\sum }_{( {c}^{″} , {L}^{″} ) ∈ {Z}^{′} , Parent ( {L}^{″} ) = L}^{ } ( {c}^{″} \times I ( {L}^{″} , L ) ) \\ and \\ Z = \{ ( {c}^{″} , {L}^{″} ) where ( {c}^{″} , {L}^{″} ) ∈ {Z}^{′} , Parent ( {L}^{″} ) \neq L \} \\ and \\ ( {c}^{′} , {Z}^{′} ) = ( {s}^{′} ) . & ( 4 )\end{matrix}$$

For any loop L, Parent(L) denotes the outermost dominating loop L′ such that I(L,L′) # ∞, if any such loop L′ exists and if T(L)=∞. Otherwise Parent(L)=undefined. B recurs over the annotated syntax of the statement s. It is aided by I(L,L′) and T(L) computed as described above. B returns a pair (c,Z), where c denotes the cost of s excluding the cost of any loop Lᵢ such that (cᵢ,Lᵢ) ∈ Z. Furthermore, for any loop Lᵢ, there is at most one entry of the form (cᵢ,Lᵢ) in Z, and cᵢ denotes the cost of the loop body of the loop Lᵢ.

The bases cases are skip, assignment, and assume statements (Eqn. 1) where the cost is 1 and there are no loops to exclude. Sequential composition (Eqn. 3) is the sum of the costs and combines loop exclusions; non-deterministic choice is similar (Eqn. 2). When the B reaches a loop L (Eqn. 4), bound calculation is more subtle. The cost in this case is not given directly because the context of the loop is unknown. Instead, the cost is deferred by accumulating a pair (c,L) where c is the cost of the body of the loop, which is multiplied in a future recursive call by outer loops where the context is known. However, the technique needs to process the cost of other inner loops L″ that have been deferred to be processed in the current context of L. Ultimately, the base case is reached, where BOUND(s) can now be obtained directly:

$$BOUND ( s ) = c + {\sum }_{( {c}^{′} , {L}^{′} ) ∈ Z}^{ } {c}^{′} \times T ( {L}^{′} )$$

$$where ( c , Z ) = ( s )$$

Theorem (Bound Computation via Progress Invariants)

The complexity of a procedure, assuming a unit cost model for all atomic statements and procedure calls, is bounded by BOUND(P).

By way of example, consider the following procedure P with two disjoint parallel inner loops L₁ and L₂ nested inside a outer loop L.

| | |
|---|---|
| i:=j:=k:=0; while(i++<n) { | if (*) while(j++<m); |
| | else while(k++<m); } |

Given that T(L₁)=T(L₂)=m and T(L)=n, BOUND(P)=n+2m. (Note n+m is not a correct answer, while n×m is correct but conservative.) This example demonstrates a subtle aspect of B. The elements of a pair of cost and deferred loop (c,Z) (arising from recursive invocations on sub-structures of s) need to be tallied differently. Where Z is tallied identically under sequential composition (Eqn. 3) and non-deterministic choice (Eqn. 2), c is instead aggregated as summation and max, respectively.

In the example of FIG. 2, it was concluded that T(L₃)=N, T(L₁)=n, and I(L₂,L₁)=m. Using the above definitions of BOUND and B, BOUND(NestedLoop)=n+(m×n)+N.

Consider also the cyclic example described above: Let L₅ₐ and L_{5b} be the first and second loops on Line 5, and let L₆ be the loop on Line 6. There are no nested loops, but using INIT_{D} and NEXT_{D}, BOUNDFINDER finds that T(L₅ₐ)=T(L₆ₐ)=maxId−id and that T(L_{5b})=id. It is straightforward to check that BOUND(cyclic)=maxId+1.

The bound computation described above assigns a unit cost to all atomic statements including procedure calls. However, in order to obtain an interprocedural computation complexity, the cost for a procedure call x:=P(y) may be computed using a known process. The formal inputs of procedure P are replaced by actuals y in the bound expression BOUND(P), then this is translated to a bound only in terms of the inputs of the enclosing procedure by using the invariants at the procedure call site that relate y with the procedure inputs. This process works only for non-recursive procedures that need to be analyzed in a top-down order of the call-graph.

In one implementation of BOUNDFINDER, several lemma “patterns” are implemented for each of the iteration classes, to search for a pattern that matches the output of progress invariants NEXT_{D} and INIT_{D}:
Arithmetic Iteration. Many loops use simple arithmetic addition for iteration, having an initial value for the iterator, a maximum (or minimum) loop condition, and an increment (or decrement) step in the body of the loop.
Bit-wise Iteration. Some loop bodies either have a left/right shift or an inclusive OR operation with a decreasing operand.
Data Structure Iteration. Patterns may be implemented for iterations over linked list fields (e.g. x=x→next), encapsulated iterators (e.g. x=GetNext(I)), and destructive iteration (e.g. x=RemoveHead(I)).

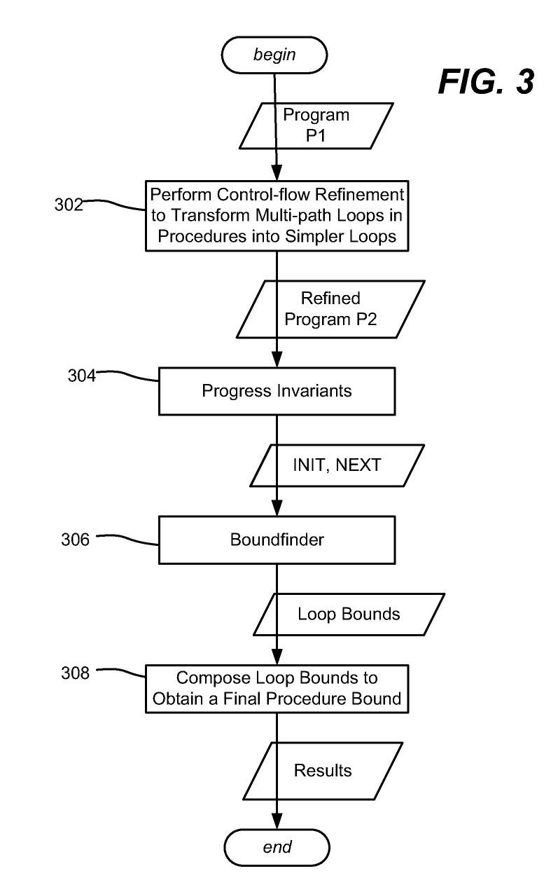

FIG. 3 is a flow diagram showing example steps for analyzing a program using the techniques described above. A program, P1 is fed to a mechanism that implements the control flow refinement technique where the multi-path loops in its procedures are transformed into simpler loops (step 302), providing a refined program P2. The refined program is provided to a mechanism that implements the progress invariants technique to generate the INIT, NEXT progress invariants (step 304) based upon the refined program.

A mechanism that implements BOUNDFINDER processes the progress invariants to determine loop bounds (step 306). These loop bounds are then combined appropriately to generate a bound for the entire procedure (step 308).

### EXEMPLARY OPERATING ENVIRONMENT

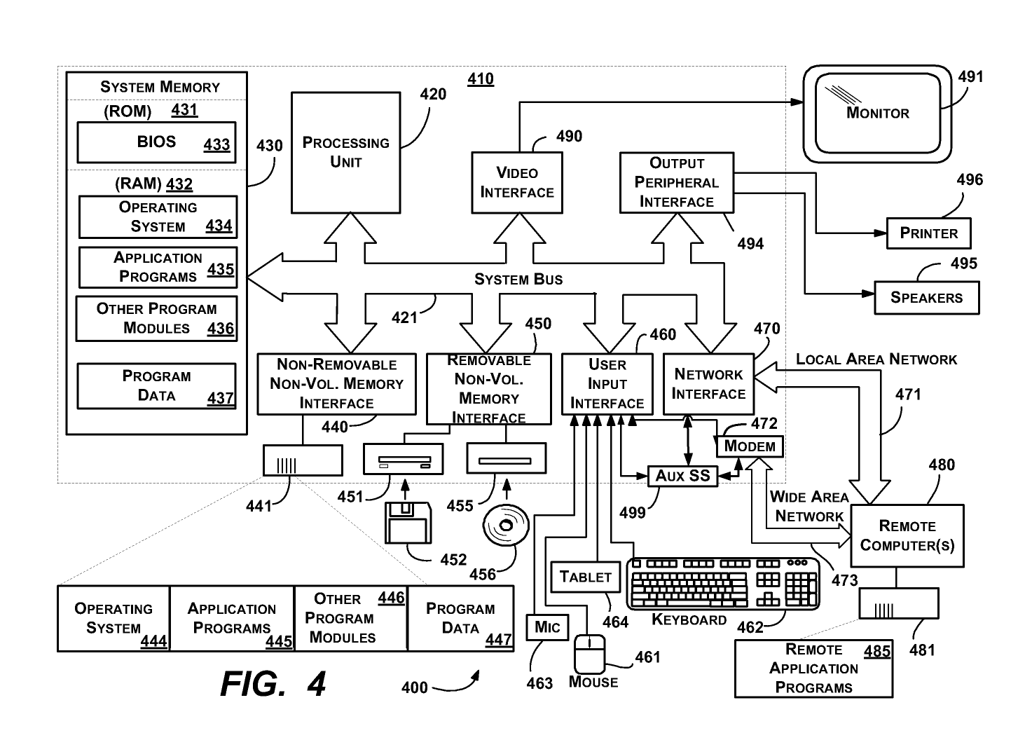

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, converting original program code into refined program code, including by expanding a multi-path loop into code-fragment comprising of simpler loops, to enable more precise computational complexity estimation.

2. The method of claim 1 wherein expanding the multi-path loop includes applying an unrolling transformation, including making a decision as to whether to recursively apply the transformation.

3. The method of claim 2 wherein applying the unrolling transformation involves flattening all paths inside the loop.

4. The method of claim 2 wherein an invariant generation tool is used to simplify the resulting code-fragment, and to determine whether or not to recursively apply the transformation.

5. The method of claim 2 wherein the decision to recursively apply the transformation may be based on a number of unrolling.

6. The method of claim 2 wherein the decision to recursively apply the transformation may be based on one or more widening techniques.

7. The method of claim 1, further comprising, using control-flow refinement transformation as a pre-processing step for other program analyses.

8. One or more computer-readable media having computer-executable instructions, which when executed perform steps, comprising, inputting a computer program, and computing progress invariants for a location in the program, the progress invariants representing how a program state evolves at a given control location, without any intervening visit to another given control location, to enable computation of more precise loop bounds.

9. The one or more computer-readable media of claim 8 wherein computing the progress invariants comprises computing Init and Next relations, in which the Init relation describes the program state during a first visit to the given control location, and the Next relation describes the relationship between successive states that arise at the given control location, without any intervening visit to another given control location.

10. The one or more computer-readable media of claim 9, wherein computation of Init and Next relations is enabled after a splitting transformation.

11. The one or more computer-readable media of claim 9, wherein computing the Init and Next relations comprises using an invariant generation tool.

12. The one or more computer-readable media of claim 9 having further computer-executable instructions comprising, providing the progress invariants to a bound finding mechanism to determine a bound for a number of times a given program location can be reached during program execution, without any intervening visit to another given program location.

13. The one or more computer-readable media of claim 12 wherein the progress invariants are provided to compute precise amortized bounds for nested loops.

14. The one or more computer-readable media of claim 12, wherein the bound finding mechanism is implemented using pattern matching.

15. The one or more computer-readable media of claim 14 where the pattern matching comprises identifying loop iterators based on integer counter variables, or bit-vector shifting, or list-traversal.

16. One or more computer-readable media having computer-executable instructions, which when executed perform steps, comprising computing progress invariants, providing the progress invariants to a bound finding mechanism that outputs bounds for different program locations, and composing the bounds to generate a bound for an entire procedure.

17. The one or more computer-readable media of claim 16, wherein the bound finding mechanism is invoked on progress invariants computed for pairs of control locations, including one that corresponds to a loop header of a nested loop, and another that corresponds to a loop header of an outer loop.

18. The one or more computer-readable media of claim 16 having further computer-executable instructions comprising, converting original program code into refined program code, including by expanding a multi-path loop into code-fragment comprising of simpler loops, prior to providing the progress invariants to the bound finding mechanism.

19. The one or more computer-readable media of claim 18 wherein converting the original program code into the refined program code and computing the progress invariants comprises using a same invariant generation tool.

20. The one or more computer-readable media of claim 16, wherein the bound finding mechanism is implemented using pattern matching.
